(19) United States
(12) Patent Application Publication
(10) Pub. No.: US 2012/0280430 A1
(43) Pub. Date: Nov. 8, 2012

(54) COMPOSITE TOOLING CONTAINING CARBON NANOTUBES AND PRODUCTION OF PARTS THEREFROM

(75) Inventor: Melissa L. Jones, Baltimore, MD (US)

(73) Assignee: Applied Nanostructured Solutions, LLC, Baltimore, MD (US)

(21) Appl. No.: 13/102,015

(22) Filed: May 5, 2011

(51) Int. Cl. B29C 35/08; C09K 5/14; B29C 35/04; B29C 33/40; B29C 41/42; B29C 59/02; B29C 47/00; B29C 45/02; B29C 43/02; B29C 45/00; B23K 20/24; B32B 37/00

(52) U.S. Cl. 264/400; 228/203; 252/67; 264/401; 264/299; 264/220; 264/293; 264/300; 264/308; 264/338; 264/176.1; 156/60; 264/319; 264/328.1; 264/334

(57) ABSTRACT

Toolings containing a composite having a coefficient of thermal expansion of less than about 5 ppm/° C. are described. The composites contain a matrix material and a carbon nanotube material and are operable for forming a part thereon. Methods for forming such toolings and use of such toolings to form parts thereon are also described. The carbon nanotube material can be a carbon nanotube-infused fiber material. Use of the carbon nanotube material in the tooling allows decreased curing and consolidation process times of the part to be realized.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention generally relates to composite materials, and, more specifically, to forming parts using composite tooling techniques.

### BACKGROUND

When manufacturing parts containing various materials, a tooling is often used as a template to form the part. Tooling can be made of metallic matrix materials including, for example, INVAR (a nickel-steel alloy that is a registered trademark of ArcelorMittal), steel, nickel, and aluminum. A more recent trend in tooling has been to use composite materials such as, for example, silicone rubbers or other polymer matrices containing materials such as, for example, carbon fiber to form the tooling. When composite materials are used to form the tooling, the manufacture of parts therefrom is often referred to as composite tooling. Selection of the matrix material for the tooling is typically based on, at least in part, the tooling's coefficient of thermal expansion (CTE), the expected number of curing cycles, the final tolerance requirements of the part, the curing method, and the cost.

FIG. 1 shows a schematic of an illustrative prior art tooling 101 and part 103 formed thereon. Intermediate material 102 separates tooling 101 and part 103. As shown in FIG. 1, part 103 is made up of four layers 104-107, although any number of layers can be used.

A significant issue that can be encountered with the use of tooling to form parts is a CTE mismatch between the tooling and part. The formation of a part using a tooling often includes a heated cure, where CTE mismatch can become particularly problematic. In addition to the CTE mismatch, the thermal and mechanical properties of the tooling and its mechanical interaction with the part can influence the curing process and ultimately impact the properties of the final part. CTE mismatch between a tooling and a part can be too extreme for parts having rigid tolerance specifications. For many applications, only higher-priced metal alloys, including INVAR, offer an acceptable CTE match. It should be noted that this alloy does offer good thermal conductivity to facilitate curing of a part. Although routinely used, the cost of INVAR can be prohibitive, especially for large parts. Further, for large parts, the sheer size and weight of the tooling can make handling difficult. Composite toolings can offer a better CTE match to a part being formed thereon, but they generally do not have the advantageous high thermal conductivity of metal alloy toolings.

In view of the foregoing, thermally conductive composite toolings that are lighter in weight, lower in cost, and have a good CTE match to materials commonly used to form parts would be of substantial benefit in the art. The present disclosure satisfies these needs and provides related advantages as well.

### SUMMARY

In some embodiments, toolings are described herein. The toolings comprise a composite that contains a matrix material and a carbon nanotube material, wherein the composite has a coefficient of thermal expansion less than about 5 ppm/° C.

In some embodiments, methods for forming a tooling are described herein. The methods include impregnating a matrix material with a carbon nanotube material to form a composite, and shaping the composite into a template structure.

In some embodiments, methods for forming a part are described herein. The methods include disposing a part material on a tooling comprising a matrix material and a carbon nanotube material, and curing the part. The tooling provides a template structure for the part being formed thereon.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 shows a schematic of an illustrative prior art tooling and part formed thereon;

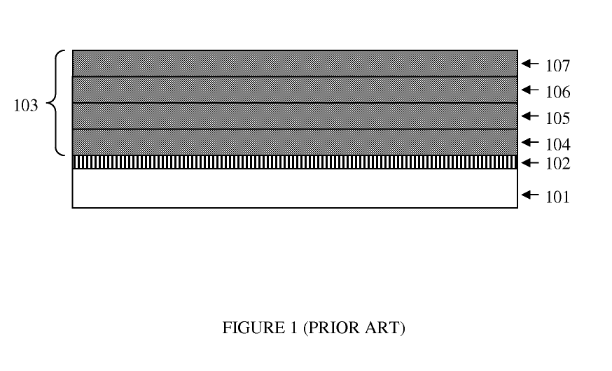

FIG. 2 shows a schematic of an illustrative tooling and part formed thereon, wherein the tooling contains carbon nanotubes; and

FIG. 3 shows a schematic displaying curing of an illustrative part by application of external heat and carbon nanotube activation.

### DETAILED DESCRIPTION

The present disclosure relates, in part, to toolings containing a carbon nanotube material and methods for making the toolings. The present disclosure also relates, in part, to production of parts from toolings containing a carbon nanotube material.

In composite materials containing a filler material and a matrix material, physical and/or chemical properties of the filler material can be imparted to the matrix material to convey desirable features of both components to the composite material. In the present embodiments, the electrical and thermal conductivity of a composite material can be adjusted by adding a filler material containing a carbon nanotube material to a matrix material. Particularly, a carbon nanotube material allows the electrical and thermal conductivity of a composite material to be increased. These composite materials can advantageously be used for composite tooling applications, particularly for the formation of parts having rigid tolerance specifications. Specifically, these composite materials can offer a good CTE match to materials typically used to form parts, while having an improved thermal conductivity that allows for a more efficient curing of parts to be realized.

By including a sufficient amount of a carbon nanotube material in a tooling, more efficient heating and cooling of the tooling can be realized without a significant change in volume expansion occurring. That is, in composite materials having a good CTE match to materials typically used to form parts, the inclusion of a carbon nanotube material does not adversely affect the good CTE match. However, the inclusion of the carbon nanotube material can significantly facilitate the formation of parts, as described herein.

An advantage of the present embodiments is that the good thermal conductivity of the carbon nanotube material in the tooling can allow more efficient curing of parts to be realized. In conventional composite tooling applications, curing of a part involves gradually heating the part, most commonly through raising the temperature via externally applied heat. If the tooling does not have a sufficiently high thermal conductivity, layers of the part closest to the tooling can be at lower temperatures than the outer layers of the part being directly exposed to the heated environment. This temperature gradient can result in curing of the outer layers of the part before the layers closest to the tooling, which can cause volatiles to become trapped within part. Differential curing and trapping of volatiles can adversely influence the properties of the final part.

To combat differential curing of a part, curing processes in conventional composite tooling applications can be conducted at very slow thermal ramp rates (e.g. about 2 to about 4° C./min) and holding between ramps at a stabilization temperature in about 10° C. intervals. Additionally, consolidation processes (i.e., intermediate curing or debulking operations) can be performed between the application of only a few layers of the part, typically between every layer to about every fourth layer or more. The enhanced thermal conductivity provided by the carbon nanotube material in the present embodiments can beneficially facilitate increased thermal ramp rates, increased intervals between stabilization temperatures, and increased numbers of layers between consolidation process operations. Thus, the carbon nanotube material in the tooling of the present embodiments allows decreased curing times and decreased consolidation process times to be realized. This feature again results in beneficial time and cost savings.

Using a carbon nanotube material in a tooling can also convey the beneficial mechanical and electrical properties of the carbon nanotube material to the tooling. In particular, the electronic band structure of the carbon nanotubes can be exploited to further enhance the tooling by expanding the possible heating modes through which curing can take place. The addition of a carbon nanotube material to a tooling can convey improved properties to the tooling in a number of ways including, for example, increasing the tooling lifetime (i.e. more heating and cooling cycles), allowing faster thermal ramp rates during curing, allowing more part layering between consolidation processes (e.g. debulking operations), facilitating heating methods during curing that are not possible without the carbon nanotube material, and decreasing the weight of the tooling to provide easier handling, particularly of a large tooling. Any combination of these advantages and others previously mentioned can lead to significant cost savings in materials, personnel time, manufacturing time, and manufacturing process simplicity.

As used herein, the term “tooling” refers to an object or objects that act as a template structure for forming a part having a desired shape thereon. A tooling can include, without limitation, patterns, stencils, molds, guides, casts, dies, stamps, frames, or the like.

As used herein, the term “part” refers to an object formed using a tooling.

As used herein, the terms “matrix material” or “tooling matrix material” equivalently refer to any material, known or unknown, that can be used to form a tooling.

As used herein, the term “carbon nanotube material” refers to a material that contains at least some carbon nanotubes.

As used herein, the term “infused” refers to being bonded and “infusion” refers to the process of bonding. As such, a “carbon nanotube-infused fiber” material refers to a fiber material that has carbon nanotubes bonded thereto. Such bonding of carbon nanotubes to a fiber material can involve mechanical attachment, covalent bonding, ionic bonding, pi-pi interactions, and/or van der Waals force-mediated physisorption. In some embodiments, the carbon nanotubes are directly bonded to the fiber material. In other embodiments, the carbon nanotubes are indirectly bonded to the fiber material via a barrier coating and/or a catalytic nanoparticle used to mediate growth of the carbon nanotubes. The particular manner in which the carbon nanotubes are infused to the fiber material can be referred to as the bonding motif.

As used herein, the term “nanoparticle” refers to particles having a diameter between about 0.1 nm and about 100 nm in equivalent spherical diameter, although nanoparticles need not necessarily be spherical in shape.

As used herein, the terms “sizing agent” or “sizing,” collectively refer to materials used in the manufacture of fiber materials that act as a coating to protect the integrity of the fiber material, to provide enhanced interfacial interactions between the fiber material and a matrix material, and/or to alter and/or to enhance certain physical properties of the fiber material.

As used herein, the term “spoolable dimensions” refers to fiber materials that have at least one dimension that is not limited in length, thereby allowing the fiber material to be stored on a spool or mandrel following infusion with carbon nanotubes. Fiber materials of “spoolable dimensions” have at least one dimension that indicates the use of either batch or continuous processing for carbon nanotube infusion to the fiber material.

As used herein, the term “transition metal” refers to any element or alloy of elements in the d-block of the periodic table (Groups 3 through 12), and the term “transition metal salt” refers to any transition metal compound such as, for example, transition metal oxides, carbides, nitrides, and the like. Illustrative transition metals that form catalytic nanoparticles suitable for synthesizing carbon nanotubes include, for example, Ni, Fe, Co, Mo, Cu, Pt, Au, Ag, alloys thereof, salts thereof, and mixtures thereof.

As used herein, the term “uniform in length” refers to a condition in which carbon nanotubes have lengths with tolerances of plus or minus about 20% or less of the total carbon nanotube length, for carbon nanotube lengths ranging between about 1 μm to about 500 μm. At very short carbon nanotube lengths (e.g., about 1 μm to about 4 μm), the tolerance can be plus or minus about 1 μm, that is, somewhat more than about 20% of the total carbon nanotube length.

As used herein, the term “uniform in density distribution” refers to a condition in which the carbon nanotube density on a fiber material has a tolerance of plus or minus about 10% coverage over the fiber material surface area that is covered by carbon nanotubes.

In some embodiments, toolings containing a carbon nanotube material are described herein. In some embodiments, methods for forming a tooling containing a carbon nanotube material are described herein. In some embodiments, methods for forming a part on a tooling containing a carbon nanotube material are described herein.

In some embodiments, toolings are described herein. The toolings comprise a composite that contains a matrix material and a carbon nanotube material, wherein the composite has a coefficient of thermal expansion less than about 5 ppm/° C.

In some embodiments, methods for forming a tooling are described herein. The methods include impregnating a matrix material with a carbon nanotube material to form a composite, and shaping the composite into a template structure.

In some embodiments, methods for forming a part are described herein. The methods include disposing a part material on a tooling comprising a matrix material and a carbon nanotube material, and curing the part. The tooling provides a template structure for the part being formed thereon.

The toolings of the present embodiments include a matrix material and a carbon nanotube material, thereby forming a composite. As noted above, inclusion of the carbon nanotube material in the matrix material of the composite advantageously improves the composite's thermal and electrical conductivity, thereby allowing more efficient curing of a layered composite material (e.g., a part) to take place thereon. The identity of the matrix material is not particularly limited, as long as a carbon nanotube material can be effectively incorporated therein and the matrix material has an acceptable CTE. In some embodiments, the matrix material can include materials such as, for example, polymer matrices, metal matrices, carbon matrices, ceramic matrices, and combinations thereof.

A wide variety of polymer matrices can be used in the present embodiments. A polymer matrix of a tooling can include, for example, thermoset polymers, thermoplastic polymers, and natural or synthetic rubbers (e.g., elastomers). In various embodiments, polymer matrices can include, for example, epoxy-based polymers, polyetheretherketone (PEEK), cyanate ester-based polymers, phenolic-based polymers, polyimide based polymers, copolymers thereof, and combinations thereof.

Illustrative thermoset polymers that can be useful as matrix materials in the present embodiments include, for example, polyesters, phthalic/maelic type polyesters, vinyl esters, epoxies, phenolics, silicones, cyanates, bismaleimides, polyimides, nadic end-capped polyimides (e.g., PMR-15), and the like. Illustrative thermoplastic polymers that can be suitable for use in the present embodiments include, for example, polysulfones, polyamides, polycarbonates, polyphenylene oxides, polysulfides, polyether ether ketones, polyether sulfones, polyamide-imides, polyetherimides, polyimides, polyacrylates, and liquid crystalline polyester. Thermoplastic polymers that can be particularly suitable for producing large toolings include, for example, acrylonitrile butadiene styrene (ABS), polycarbonate, and nylon.

The carbon nanotube material can be incorporated into a thermoset matrix material through various techniques, including but not limited to, any current technique used to incorporate glass fibers, carbon fibers, or other fillers into a composite structure. Polyester resin can be used, for example, for the creation of bulk-molding compound (BMC) or sheet molding compound (SMC). The carbon nanotube material can be incorporated into BMC or SMC, thereby providing a multi-length scale reinforcement which can be utilized in a composite structure previously created with BMC or SMC not including carbon nanotube material.

In some embodiments, methods of shaping the tooling include the use of prepregs, resin film infusion, chopped fiber layup, resin transfer molding and wet winding, vacuum assisted resin transfer molding (VARTM), and any other technique employed in the art in composite manufacture. Non-limiting examples include, for example, pultrusion, extrusion, hand layup open molding, compression molding, thermoforming, autoclave molding, and filament winding.

In some embodiments, the carbon nanotube material can be impregnated in a softened thermoplastic matrix material. In some embodiments, this can further involve chopping the impregnated carbon nanotube material into pellets, and molding (or shaping) the pellets to form a tooling. In some embodiments, molding can involve injection molding or press molding, for example. In some embodiments, the method can further include diluting the pellets containing the carbon nanotube material with thermoplastic pellets lacking a carbon nanotube material. By tailoring the amount of additional pellets lacking a carbon nanotube material, the amount of carbon nanotube material in the composite can be controlled.

In a like manner, a wide variety of metal matrices can be used in forming the toolings described herein. In some embodiments, the metal matrix can include at least one metal such as, for example, aluminum, magnesium, copper, cobalt, nickel, zirconium, silver, gold, titanium, and mixtures thereof. A mixture of metal matrices can also be used as a metal alloy. As a non-limiting examples, illustrative metal alloys include, for example, a nickel-cobalt alloy, stainless steel, and INVAR (a nickel steel alloy).

A carbon matrix can also be used as the matrix material of the tooling in various embodiments. The carbon matrix can be formed by impregnating a carbon nanotube material with an organic resin and then heating or pyrolyzing the mixture to carbonizing temperatures. A variety of methods and carbon matrix precursor materials for making a carbon matrix are known in the art and will be evident to one having ordinary skill in the art. The carbon matrix of the present embodiments can employ any precursor carbon source known in the art. In some embodiments, the carbon matrix is derived from an organic resin. Organic resins suitable for forming a carbon matrix include, for example, phenolic resins, phthalonitriles, and mixed phenolic-furfuryl alcohol. In some embodiments the carbon matrix is derived from a tar or pitch. Hydrocarbon materials, such as those employed in chemical vapor deposition/chemical vapor infiltration (CVD/CVI), for example, can also be used to generate the carbon matrix in various embodiments.

The carbon matrix can also include any number of additives within the carbon matrix in order to modify its properties. In some embodiments, the carbon matrix can further include a matrix modifier that includes phosphorus or boron. Such matrix modifiers can act to reduce the detrimental effects of oxidation that can be problematic at elevated temperatures. Other additives to a carbon matrix can include a dopant carbon nanostructure selected from the group consisting of loose carbon nantoubes, fullerenes, nano-onions, nanoflakes, nanoscrolls, nanopaper, nanofibers, nanohorns, nanoshells, nanowires, nanosprings, nanocrystals, nanodiamonds, bucky diamond, nanocontainers, nanomesh, nanosponges, nano-scaled graphene plates (NGPs), and nanobeads. In some embodiments, a dopant carbon nanostructure can be fabricated in situ during densification of the carbon matrix, while in other embodiments, the dopant carbon nanostructures can be added as pre-fabricated components prior to densification and, in some embodiments, even prior to a first pyrolysis step prior to densification. In some embodiments, one or more of the aforementioned carbon nanostructures and/or any matrix modifiers can be added during any initial pyrolysis step and during any number of subsequent densification steps.

A wide variety of ceramic matrices can likewise be used in forming the toolings described herein. In some embodiments, the ceramic matrices are binary, ternary or quaternary ceramic materials. In some embodiments, the ceramic matrices are carbides, nitrides, borides or oxides. In some embodiments, the ceramic matrices include at least one compound such as, for example, silicon carbide, tungsten carbide, chromium carbide (Cr₃C₂), titanium carbide (TiC), titanium nitride (TiN), titanium boride (TiB₂), aluminum oxide, and silicone nitride (Si₃N₄). In additional embodiments, other suitable ceramic matrices can include, for example, SiCN, Fe₂N, and BaTiO₃. In still additional embodiments, ceramic matrices can include lithium aluminosilicate or mullite (a silicate mineral having two stoichiometric forms: 3Al₂O₃.2SiO₂ or 2Al₂O₃.SiO₂)

Composites containing a ceramic matrix and a carbon nanotube material can be formed using any method known to one of ordinary skill in the art including, for example, chemical vapor infiltration, reactive melt infiltration, electrophoretic deposition, polymer impregnation and pyrolysis, sintering, colloidal deposition, sol-gel deposition, and powder processing.

In addition to the carbon nanotube material, other non-nanotube filler materials can be included in the present toolings. Illustrative filler materials include fibers, plasticizers, and the like. In some embodiments, additional thermally conductive filler materials can be included in the tooling. In one embodiment, nanoscale silver can be included in the tooling. The nanoscale silver can be included in the matrix material of the tooling and/or coated on a fiber material incorporated therein. Optionally, nanoscale silver can be used in place of the carbon nanotube material. Additionally, after being formed the tooling can be coated with a material that further improves the tooling's thermal conductivity or mechanical properties.

One of ordinary skill in the art will recognize that there are a multitude of methods capable of impregnating or incorporating the carbon nanotube material with the matrix material. In various embodiments, the matrix material can be impregnated or incorporated with a carbon nanotube material by methods including, but not limited to, wet mixing, dry mixing, layering, in situ growth, chemical vapor infiltration, reactive melt infiltration, electrophoretic deposition, polymer impregnation and pyrolysis, sintering, colloidal deposition, sol-gel deposition, powder processing, and combinations thereof.

The method for forming or shaping a tooling is not particularly limited and can include many techniques known to one of ordinary skill in the art. For example, the toolings described herein can be formed by methods including, but not limited to, die casting, mold casting, extruding, layering, machining, laser cutting, machine stamping, welding, prepregs, resin film infusion, chopped fiber layup, resin transfer molding and wet winding, vacuum assisted resin transfer molding (VARTM), pultrusion, extrusion, hand layup open molding, compression molding, thermoforming, autoclave molding, filament winding, injection molding, press molding, and combinations thereof.

In various embodiments, the carbon nanotube material can be predominantly single-wall carbon nanotubes, double-wall carbon nanotubes, or multi-wall carbon nanotubes. As used herein, the term “carbon nanotube” refers generally to single-wall carbon nanotubes, double-wall carbon nanotubes, and multi-wall carbon nanotubes, any of which can be used singularly or in combination with one another in the present embodiments. For example, if desired, carbon nanotube materials of different lengths, diameters and/or types can be used in different parts of the tooling. As described below, carbon nanotubes having different properties can be obtained by varying these parameters and others.

The types of carbon nanotubes in the present embodiments can generally vary without limitation. The carbon nanotubes can be metallic, semimetallic, or semiconducting depending on their chirality. An established system of nomenclature for designating carbon nanotube chirality is recognized by one of ordinary skill in the art and is distinguished by a double index (n,m), where n and m are integers that describe the cut and wrapping of hexagonal graphite when formed into a tubular structure. In addition to chirality, a carbon nanotube's diameter also influences its electrical conductivity and the related property of thermal conductivity. In the synthesis of carbon nanotubes, a carbon nanotube's diameter can be controlled by using catalytic nanoparticles of a given size. Typically, a carbon nanotube's diameter is approximately that of the catalytic nanoparticle that catalyzes its formation. Therefore, the carbon nanotubes' properties can be controlled in one respect by adjusting the size of the catalytic nanoparticles used for carbon nanotube growth, for example. By way of non-limiting example, catalytic nanoparticles having a diameter of about 1 nm can be used to prepare single-wall carbon nanotubes. Larger catalytic nanoparticles can be used to prepare predominantly multi-wall carbon nanotubes, which have larger diameters because of their multiple nanotube layers, or mixtures of single-wall and multi-wall carbon nanotubes. Multi-wall carbon nanotubes typically have more complex electrical and thermal conductivity profiles than do single-wall carbon nanotubes due to interwall reactions that can occur between the individual nanotube layers and redistribute current non-uniformly. By contrast, there is no change in the electrical and thermal conductivity profiles across different portions of a single-wall carbon nanotube.

The carbon nanotubes used in the present embodiments can be made by any known technique, for example, arc methods, laser oven, chemical vapor deposition, flame synthesis, and high pressure carbon monoxide (HiPCO). The carbon nanotubes be in a variety of forms, e.g., soot, powder, fibers, “bucky papers,” etc. Carbon nanotubes can be in their raw, as-produced form, or they can be purified by a purification technique, if desired. Furthermore, mixtures of raw and purified carbon nanotubes may be used. In some embodiments, the carbon nanotubes can be in a substantially debundled state. That is the carbon nanotubes are substantially present as individual carbon nanotubes. In alternative embodiments, however, the carbon nanotubes can be present as ropes or bundles of carbon nanotubes.

In some embodiments, the carbon nanotubes can be capped with a fullerene-like structure. Stated another way, the carbon nanotubes have closed ends in such embodiments. However, in other embodiments, the carbon nanotubes can remain open-ended. In some embodiments, closed carbon nanotube ends can be opened through treatment with an appropriate oxidizing agent (e.g., HNO₃/H₂SO₄). In some embodiments, the carbon nanotubes can encapsulate other materials.

In various embodiments, the carbon nanotubes can be functionalized to increase the compatibility of the carbon nanotubes with the matrix material, for example. Functionalized carbon nanotubes, as used herein, can be obtained by the chemical modification of any of the above-described carbon nanotube types. Such modifications can involve the carbon nanotube ends, sidewalls, or both. Chemical modification can include, but is not limited to, covalent bonding, ionic bonding, chemisorption, intercalation, surfactant interactions, polymer wrapping, cutting, solvation, and combinations thereof. In some embodiments, the carbon nanotubes can be functionalized by exposure to a plasma.

The thermal conductivity of carbon nanotubes is generally good along the length of the carbon nanotubes, while the thermal conductivity across the diameter of the carbon nanotubes is generally poor. Therefore, in some embodiments, the carbon nanotubes can be aligned to provide for increased thermal conductivity within the tooling. That is, in some embodiments, the carbon nanotube material in the tooling contains carbon nanotubes that are aligned substantially parallel to one another.

In composite materials, carbon nanotube length translates to a variable percolation concentration. Percolation concentration or percolation threshold is a carbon nanotube concentration sufficient to create a network of carbon nanotubes through which thermal energy can be transported from a first point to a second point. Generally, the percolation concentration for longer carbon nanotubes is lower than of shorter carbon nanotubes.

Enhancement of the thermal conductivity of a tooling does not require the carbon nanotube material to be at a percolation concentration therein. Even in a matrix material having an inherent thermal conductivity and a carbon nanotube material therein with a concentration below the percolation concentration, thermal energy can be transported through a combination of the matrix material and the carbon nanotube material. Therefore, carbon nanotube material concentrations above, at, or below the percolation concentration are included in the present embodiments.

In various embodiments, the carbon nanotube material can be carbon nanotubes or carbon nanotubes attached to a substrate such as, for example, a fiber, a scroll, a sheet, a spherical particle, a non-spherical particle, or the like. The substrate can range in scale from nanometer size to millimeter and higher size.

In some embodiments, the carbon nanotube material can be a carbon nanotube-infused fiber material. Such carbon nanotube-infused fiber materials are described in commonly owned U.S. patent application Ser. Nos. 12/611,073, 12/611,101, and 12/611,103, all filed on Nov. 2, 2009, and Ser. No. 12/938,328, filed on Nov. 2, 2010, each of which is incorporated herein by reference in its entirety. Illustrative fiber types that can be infused with carbon nanotubes include, for example, carbon fibers, glass fibers, metal fibers, ceramic fibers and organic (e.g., aramid) fibers, any of which can be used in the present embodiments. As described in these co-pending patent applications, a fiber material is modified to provide a layer (typically no more than a monolayer) of catalytic nanoparticles on the fiber material for the purpose of growing carbon nanotubes thereon. Such carbon nanotube-infused fiber materials can be readily prepared in spoolable lengths from commercially available continuous fibers or continuous fiber forms (e.g., fiber tows or fiber tapes). Shortening of the continuous fibers into chopped fibers can take place following carbon nanotube infusion thereon, if desired. Additional disclosure regarding carbon nanotube-infused fiber materials is presented hereinafter. Carbon nanotube-infused fiber materials are particularly advantageous for the present embodiments, since they allow easy placement of the carbon nanotube material in the tooling.

In some embodiments, the carbon nanotube material and matrix material of the tooling can be combined by methods including, but not limited to, dry-mixing, wet-mixing, layering, in situ carbon nanotube growth, impregnating, and combinations thereof. In some embodiments, the tooling can contain one or more layers. One of ordinary skill in the art will recognize that the number of chosen layers for the tooling can be chosen arbitrarily to construct a tooling having a desired shape and thickness. In some embodiments, the tooling can contain about 1% to about 99% carbon nanotubes by weight. In other embodiments, the tooling can contain about 50% to about 75% carbon nanotubes by weight.

As a result of including a carbon nanotube material therein, toolings of the present embodiments can have a greater thermal or electrical conductivity than a like tooling lacking carbon nanotubes. The matrix material of the tooling can be chosen such that it has CTE that is compatible with a part being formed thereon. In some embodiments, the tooling can have a CTE of less than about 5 ppm/° C. In other embodiments, the tooling can have a CTE of less than about 1 ppm/° C. or less than about 0.5 ppm/° C. CTEs of this magnitude make the toolings of the present embodiments comparable to toolings constructed from high cost materials like INVAR.

In some embodiments, the carbon nanotube material can be distributed uniformly in the tooling. In other embodiments, the carbon nanotube material can be distributed non-uniformly in the tooling. A non-uniform distribution includes, for example, a varying concentration of carbon nanotube material in some or all of the tooling in a smooth gradient, in a stepped gradient, in discontinuous micro-structures, in networks, and combinations thereof. In some embodiments, a concentration of the carbon nanotube material in the tooling is highest at a surface of the composite forming the tooling. That is, a concentration of the carbon nanotube material is highest where the tooling is nearest a part formed thereon. This type of gradient placement of the carbon nanotube material in the tooling beneficially allows the highest heat transfer to take place as close as possible to the attachment point of a part being formed on the tooling.

Depending on the matrix material, the tooling may need to be cured prior to formation of an intermediate material or a part thereon. One of ordinary skill in the art can determine appropriate curing methods. If the curing method includes thermal heating, the carbon nanotubes can be activated to produce a thermal emission for curing. Activation can include, for example, near-infrared radiation, radio-frequency radiation, microwave radiation, electrical current, and combinations thereof. Alternately, application of an external heat source can be used for curing in some embodiments.

In various embodiments, an intermediate material can be disposed on the tooling. When a part is disposed on the tooling, the intermediate material is between the tooling and the part. The intermediate material can serve many functions including, but not limited to, providing an adhesive interface between the tooling and the part, providing thermal conductivity between the tooling and the part, providing easy separation of the part after curing, and combinations thereof. One of ordinary skill in the art can determine an appropriate intermediate material based on the composition of the tooling and part to be formed.

In some embodiments, the intermediate material contains one or more layers. One of ordinary skill in the art will recognize that the number of layers can be chosen arbitrarily to form an intermediate material of a desired thickness. In some embodiments, at least a portion of the intermediate material also contains a carbon nanotube material. The carbon nanotube material in the intermediate material can be the same as or different than the carbon nanotube material included in the tooling. A carbon nanotube material can be incorporated into the intermediate material in many ways including, for example, as part of a tape, a fiber, a fabric, a paint, a glue, a coating, a film, an aerosolized liquid, any equivalent thereof, and any combination thereof. In some embodiments, a carbon nanotube material can be incorporated in the intermediate material as a carbon nanotube-infused fiber material.

In some embodiments, a part can be formed on a tooling or an intermediate material on a tooling by way of use of a part material. By way of non-limiting example, the part can be predominantly made of a metal, an alloy, a polymer, a ceramic, or combinations thereof. One of ordinary skill in the art will recognize that the choice of material for making a part will depend on the intended end use of the part. Further, one of ordinary skill in the art will recognize that many different procedures can be used for forming the part on the tooling or the intermediate material. The part can be formed on the tooling or the intermediate material by methods including, but not limited to, pouring, spraying, layering, pressing, any equivalents thereof, and any combinations thereof. In various embodiments, the part contains one or more layers.

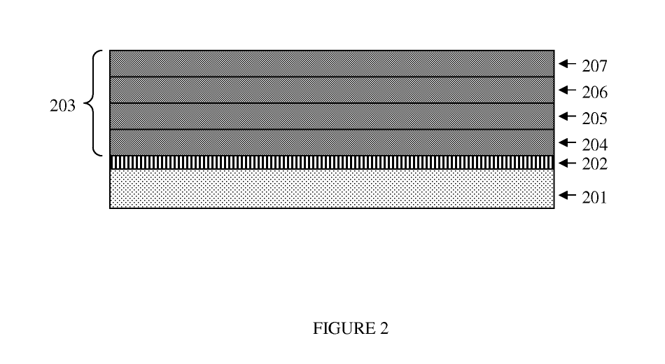

FIG. 2 shows a schematic of an illustrative a tooling 201 that contains carbon nanotubes therein and part 203 formed thereon. As in conventional composite tooling applications, part 203 is formed on tooling 201 with intermediate material 202 disposed therebetween. Although FIG. 2 has shown part 203 to be made up of four layers 204-207, any number of layers can be used. As discussed herein, the carbon nanotubes within tooling 201 are particularly useful in forming part 203.

In some embodiments, the part is layered on the tooling or the intermediate material and contains one or more layers. One of ordinary skill in the art will recognize that there are various methods for layering the part on the tooling or the intermediate material. One of ordinary skill in the art will also recognize that the number of layers can be arbitrarily chosen to form a part of a given size and shape. In some embodiments, a consolidation process (also known in the art as debulking) is performed between the application of at least some of the layers. Consolidation processes, among other advantages, removes at least some of the volatiles from the part layers. In some embodiments, a consolidation process is performed between at least every fourth layer, or at least every tenth layer, or at least every twentieth layer, for example. Consolidation processes performed between other numbers of layers or even higher numbers of layers also lies within the spirit and scope of the disclosure.

In various embodiments, properties of carbon nanotube materials to emit thermal energy and/or to transport thermal energy can be exploited to facilitate curing and/or consolidation processes.

Methods for traditional consolidation processes include increasing the ambient air temperature, circulating heated air, directly applying focused or diffuse heat, increasing the air pressure, decreasing the air pressure, applying vacuum and combinations thereof. In some embodiments, consolidation processes can be conducted by a traditional consolidation curing technique such as, for example, by applying external heat. In such embodiments, the carbon nanotube material in the tooling can aiding in transporting thermal energy from the external heat source to portions of the part closest to the tooling. In some embodiments in addition to or instead of traditional consolidation process techniques, the carbon nanotube material can be activated to produce a thermal emission for consolidation curing. Examples of activation include, but are not limited to, near-infrared radiation, radio-frequency radiation, microwave radiation, electrical current, and combinations thereof.

In some embodiments, the part can be cured. Methods for traditional curing include increasing the ambient air temperature, circulating heated air, directly applying focused or diffuse heat, increasing the air pressure, decreasing the air pressure, and combinations thereof. In some embodiments, curing can take place by traditional curing techniques such as, for example, by applying external heat. In such embodiments, the carbon nanotube material in the tooling can aid in transporting thermal energy from the external heat source to portions of the part closest to the tooling (e.g., layer 204 in FIG. 2), while the outermost layers of the part (e.g., layer 207 in FIG. 2) are cured via direct contact with the thermal energy supplied by the external heat source.

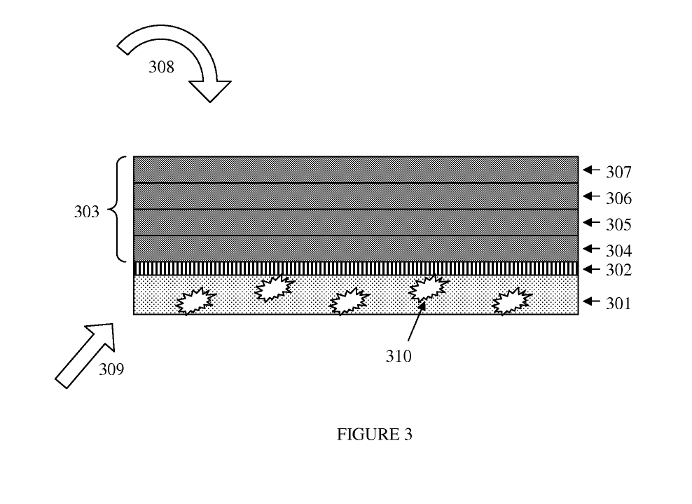

In some embodiments in addition to or instead of traditional curing methods, the carbon nanotube material can be activated to produce a thermal emission for curing. Examples of activation include, but are not limited to, near-infrared radiation, radio-frequency radiation, microwave radiation, electrical current, and combinations thereof. FIG. 3 shows a schematic displaying curing of an illustrative part 303 by application of external heat 308 and carbon nanotube activation 309. Part 303 has been formed on tooling 301 with intermediate material 302 disposed therebetween and contains four layers 304-307, although any number of layers can be used. In addition to external heat 308, curing is further aided by carbon nanotube activation 309, including those mentioned above, to produce thermal emission 310 from the carbon nanotubes in tooling 301. Thermal emission 310 can further aid in curing the layers of part 303 nearest the tooling (e.g., layer 304).

In some embodiments, the part can be released from the tooling and/or the intermediate material. One of ordinary skill in the art will recognize the proper methods for releasing the part from the tooling and/or the intermediate material.

Some embodiments disclosed herein utilize carbon nanotube-infused fibers that can be readily prepared by methods described in commonly owned U.S. patent application Ser. Nos. 12/611,073, 12/611,101, 12/611,103, and 12/938,328, each of which is incorporated by reference herein in its entirety. A brief description of the processes described therein follows.

To infuse carbon nanotubes to a fiber material, the carbon nanotubes are synthesized directly on the fiber material. In some embodiments, this is accomplished by first disposing a carbon nanotube-forming catalyst (e.g., catalytic nanoparticles) on the fiber material. A number of preparatory processes can be performed prior to this catalyst deposition.

In some embodiments, the fiber material can be optionally treated with a plasma to prepare the fiber surface to accept the catalyst. For example, a plasma treated glass fiber material can provide a roughened glass fiber surface in which the carbon nanotube-forming catalyst can be deposited. In some embodiments, the plasma also serves to “clean” the fiber surface. The plasma process for “roughing” the fiber surface thus facilitates catalyst deposition. The roughness is typically on the scale of nanometers. In the plasma treatment process, craters or depressions are formed that are nanometers deep and nanometers in diameter. Such surface modification can be achieved using a plasma of any one or more of a variety of different gases, including, without limitation, argon, helium, oxygen, ammonia, nitrogen and hydrogen.

In some embodiments, where a fiber material being employed has a sizing material associated with it, such sizing can be optionally removed prior to catalyst deposition. Optionally, the sizing material can be removed after catalyst deposition. In some embodiments, sizing material removal can be accomplished during carbon nanotube synthesis or just prior to carbon nanotube synthesis in a pre-heat step. In other embodiments, some sizing materials can remain throughout the entire carbon nanotube synthesis process.

Yet another optional step prior to or concomitant with the deposition of the carbon nanotube-forming catalyst (e.g., catalytic nanoparticles) is the application of a barrier coating onto the fiber material. Barrier coatings are materials designed to protect the integrity of sensitive fiber materials, such as carbon fibers, organic fibers, glass fibers, metal fibers, and the like. Such a barrier coating can include, for example, an alkoxysilane, an alumoxane, alumina nanoparticles, spin on glass and glass nanoparticles. The carbon nanotube-forming catalyst can be added to the uncured barrier coating material and then applied to the fiber material together, in one embodiment. In other embodiments the barrier coating material can be added to the fiber material prior to deposition of the carbon nanotube-forming catalyst. In such embodiments, the barrier coating can be partially cured prior to catalyst deposition. The barrier coating material can be of a sufficiently thin thickness to allow exposure of the carbon nanotube-forming catalyst to the carbon feedstock gas for subsequent CVD or like carbon nanotube growth process. In some embodiments, the barrier coating thickness is less than or about equal to the effective diameter of the carbon nanotube-forming catalyst. Once the carbon nanotube-forming catalyst and the barrier coating are in place, the barrier coating can be fully cured. In some embodiments, the thickness of the barrier coating can be greater than the effective diameter of the carbon nanotube-forming catalyst so long as it still permits access of carbon feedstock gases to the sites of the catalyst. Such barrier coatings can be sufficiently porous to allow access of carbon feedstock gases to the carbon nanotube-forming catalyst.

Without being bound by theory, the barrier coating can serve as an intermediate layer between the fiber material and the carbon nanotubes and can also assist in mechanically infusing the carbon nanotubes to the fiber material. Such mechanical infusion via a barrier coating provides a robust system for carbon nanotube growth in which the fiber material serves as a platform for organizing the carbon nanotubes, while still allowing the beneficial carbon nanotube properties to be conveyed to the fiber material. The benefits of mechanical infusion with a barrier coating are similar to the indirect type infusion described hereinabove. Moreover, the benefits of including a barrier coating include, for example, the immediate protection it provides the fiber material from chemical damage due to moisture exposure and/or any thermal damage at the elevated temperatures used to promote carbon nanotube growth.

As described further below, the carbon nanotube-forming catalyst can be prepared as a liquid solution that contains the carbon nanotube-forming catalyst as transition metal catalytic nanoparticles. The diameters of the synthesized carbon nanotubes are related to the size of the transition metal catalytic nanoparticles as described above.

Carbon nanotube synthesis can be based on a chemical vapor deposition (CVD) process or related carbon nanotube growth process which occurs at elevated temperatures. The specific temperature is a function of catalyst choice, but can typically be in a range of about 500° C. to about 1000° C. Accordingly, carbon nanotube synthesis involves heating the fiber material to a temperature in the aforementioned range to support carbon nanotube growth.

In some embodiments, CVD-promoted carbon nanotube growth on the catalyst-laden fiber material is performed. The CVD process can be promoted by, for example, a carbon-containing feedstock gas such as acetylene, ethylene, and/or ethanol. The carbon nanotube growth processes generally use an inert gas (e.g., nitrogen, argon, and/or helium) as a primary carrier gas. The carbon-containing feedstock gas is typically provided in a range from between about 0.1% to about 15% of the total mixture. A substantially inert environment for CVD growth can be prepared by removal of moisture and oxygen from the growth chamber.

In the carbon nanotube growth process, carbon nanotubes grow at the sites of transition metal catalytic nanoparticles that are operable for carbon nanotube growth. The presence of a strong plasma-creating electric field can be optionally employed to affect carbon nanotube growth. That is, the growth tends to follow the direction of the electric field. By properly adjusting the geometry of the plasma spray and electric field, vertically aligned carbon nanotubes (i.e., perpendicular to the longitudinal axis of the fiber material) can be synthesized. Under certain conditions, even in the absence of a plasma, closely-spaced carbon nanotubes can maintain a substantially vertical growth direction resulting in a dense array of carbon nanotubes resembling a carpet or forest.

The operation of disposing catalytic nanoparticles on the fiber material can be accomplished by a number of techniques including, for example, spraying or dip coating a solution of catalytic nanoparticles or by gas phase deposition, which can occur by a plasma process, for example. Thus, in some embodiments, after forming a catalyst solution in a solvent, the catalyst can be applied by spraying or dip coating the fiber material with the solution, or combinations of spraying and dip coating. Either technique, used alone or in combination, can be employed once, twice, thrice, four times, up to any number of times to provide a fiber material that is sufficiently uniformly coated with catalytic nanoparticles that are operable for formation of carbon nanotubes. When dip coating is employed, for example, a fiber material can be placed in a first dip bath for a first residence time in the first dip bath. When employing a second dip bath, the fiber material can be placed in the second dip bath for a second residence time. For example, fiber materials can be subjected to a solution of carbon nanotube-forming catalyst for between about 3 seconds to about 90 seconds depending on the dip configuration and linespeed. Employing spraying or dip coating processes, a fiber material with a catalyst surface density of less than about 5% surface coverage to as high as about 80% surface coverage can be obtained. At higher surface densities (e.g., about 80%), the carbon nanotube-forming catalyst nanoparticles are nearly a monolayer. In some embodiments, the process of coating the carbon nanotube-forming catalyst on the fiber material produces no more than a monolayer. For example, carbon nanotube growth on a stack of carbon nanotube-forming catalyst can erode the degree of infusion of the carbon nanotubes to the fiber material. In other embodiments, transition metal catalytic nanoparticles can be deposited on the fiber material using evaporation techniques, electrolytic deposition techniques, and other processes known to those of ordinary skill in the art, such as addition of the transition metal catalyst to a plasma feedstock gas as a metal organic, metal salt or other composition promoting gas phase transport.

Because processes to manufacture carbon nanotube-infused fibers are designed to be continuous, a spoolable fiber material can be dip-coated in a series of baths where dip coating baths are spatially separated. In a continuous process in which nascent fibers are being generated de novo, such as newly formed glass fibers from a furnace, dip bath or spraying of a carbon nanotube-forming catalyst can be the first step after sufficiently cooling the newly formed fiber material. In some embodiments, cooling of newly formed glass fibers can be accomplished with a cooling jet of water which has the carbon nanotube-forming catalyst particles dispersed therein.

In some embodiments, application of a carbon nanotube-forming catalyst can be performed in lieu of application of a sizing when generating a fiber and infusing it with carbon nanotubes in a continuous process. In other embodiments, the carbon nanotube-forming catalyst can be applied to newly formed fiber materials in the presence of other sizing agents. Such simultaneous application of a carbon nanotube-forming catalyst and other sizing agents can provide the carbon nanotube-forming catalyst in surface contact with the fiber material to ensure carbon nanotube infusion. In yet further embodiments, the carbon nanotube-forming catalyst can be applied to nascent fibers by spray or dip coating while the fiber material is in a sufficiently softened state, for example, near or below the annealing temperature, such that the carbon nanotube-forming catalyst is slightly embedded in the surface of the fiber material. When depositing the carbon nanotube-forming catalyst on hot glass fiber materials, for example, care should be given to not exceed the melting point of the carbon nanotube-forming catalyst, thereby causing nanoparticle fusion and loss of control of the carbon nanotube characteristics (e.g., diameter) as a result.

The carbon nanotube-forming catalyst solution can be a transition metal nanoparticle solution of any d-block transition metal. In addition, the nanoparticles can include alloys and non-alloy mixtures of d-block metals in elemental form, in salt form, and mixtures thereof. Such salt forms include, without limitation, oxides, carbides, and nitrides, acetates, nitrates, and the like. Non-limiting illustrative transition metal nanoparticles include, for example, Ni, Fe, Co, Mo, Cu, Pt, Au, and Ag, salts thereof, and mixtures thereof. In some embodiments, such carbon nanotube-forming catalysts are disposed on the fiber material by applying or infusing a carbon nanotube-forming catalyst directly to the fiber material. Many nanoparticle transition metal catalysts are readily commercially available from a variety of suppliers, including, for example, Ferrotec Corporation (Bedford, N.H.).

Catalyst solutions used for applying the carbon nanotube-forming catalyst to the fiber material can be in any common solvent that allows the carbon nanotube-forming catalyst to be uniformly dispersed throughout. Such solvents can include, without limitation, water, acetone, hexane, isopropyl alcohol, toluene, ethanol, methanol, tetrahydrofuran (THF), cyclohexane or any other solvent with controlled polarity to create an appropriate dispersion of the carbon nanotube-forming catalytic nanoparticles therein. Concentrations of carbon nanotube-forming catalyst in the catalyst solution can be in a range from about 1:1 to about 1:10,000 catalyst to solvent.

In some embodiments, after applying the carbon nanotube-forming catalyst to the fiber material, the fiber material can be optionally heated to a softening temperature. This step can aid in embedding the carbon nanotube-forming catalyst in the surface of the fiber material to encourage seeded growth and prevent tip growth where the catalyst floats at the tip of the leading edge a growing carbon nanotube. In some embodiments heating of the fiber material after disposing the carbon nanotube-forming catalyst on the fiber material can be at a temperature between about 500° C. and about 1000° C. Heating to such temperatures, which can also be used for carbon nanotube growth, can serve to remove any pre-existing sizing agents on the fiber material allowing deposition of the carbon nanotube-forming catalyst directly on the fiber material. In some embodiments, the carbon nanotube-forming catalyst can also be placed on the surface of a sizing coating prior to heating. The heating step can be used to remove sizing material while leaving the carbon nanotube-forming catalyst disposed on the surface of the fiber material. Heating at these temperatures can be performed prior to or substantially simultaneously with the introduction of a carbon-containing feedstock gas for carbon nanotube growth.

In some embodiments, the process of infusing carbon nanotubes to a fiber material includes removing sizing agents from the fiber material, applying a carbon nanotube-forming catalyst to the fiber material after sizing removal, heating the fiber material to at least about 500° C., and synthesizing carbon nanotubes on the fiber material. In some embodiments, operations of the carbon nanotube infusion process include removing sizing from a fiber material, applying a carbon nanotube-forming catalyst to the fiber material, heating the fiber material to a temperature operable for carbon nanotube synthesis and spraying a carbon plasma onto the catalyst-laden fiber material. Thus, where commercial fiber materials are employed, processes for constructing carbon nanotube-infused fibers can include a discrete step of removing sizing from the fiber material before disposing the catalytic nanoparticles on the fiber material. Some commercial sizing materials, if present, can prevent surface contact of the carbon nanotube-forming catalyst with the fiber material and inhibit carbon nanotube infusion to the fiber material. In some embodiments, where sizing removal is assured under carbon nanotube growth conditions, sizing removal can be performed after deposition of the carbon nanotube forming catalyst but just prior to or during providing a carbon-containing feedstock gas.

The step of synthesizing carbon nanotubes can include numerous techniques for forming carbon nanotubes, including, without limitation, micro-cavity, thermal or plasma-enhanced CVD techniques, laser ablation, arc discharge, flame synthesis, and high pressure carbon monoxide (HiPCO). During CVD, in particular, a sized fiber material with carbon nanotube-forming catalyst disposed thereon, can be used directly. In some embodiments, any conventional sizing agents can be removed during carbon nanotube synthesis. In some embodiments other sizing agents are not removed, but do not hinder carbon nanotube synthesis and infusion to the fiber material due to the diffusion of the carbon-containing feedstock gas through the sizing. In some embodiments, acetylene gas can be ionized to create a jet of cold carbon plasma for carbon nanotube synthesis. The plasma is directed toward the catalyst-laden fiber material. Thus, in some embodiments synthesizing carbon nanotubes on a fiber material includes (a) forming a carbon plasma; and (b) directing the carbon plasma onto the catalyst disposed on the fiber material. The diameters of the carbon nanotubes that are grown are dictated by the size of the carbon nanotube-forming catalyst. In some embodiments, a sized fiber material can be heated to between about 550° C. and about 800° C. to facilitate carbon nanotube growth. To initiate the growth of carbon nanotubes, two or more gases are bled into the reactor: an inert carrier gas (e.g., argon, helium, or nitrogen) and a carbon-containing feedstock gas (e.g., acetylene, ethylene, ethanol or methane). Carbon nanotubes grow at the sites of the carbon nanotube-forming catalyst.

In some embodiments, a CVD growth process can be plasma-enhanced. A plasma can be generated by providing an electric field during the growth process. Carbon nanotubes grown under these conditions can follow the direction of the electric field. Thus, by adjusting the geometry of the reactor, vertically aligned carbon nanotubes can be grown where the carbon nanotubes are substantially perpendicular to the longitudinal axis of the fiber material (i.e., radial growth). In some embodiments, a plasma is not required for radial growth to occur about the fiber material. For fiber materials that have distinct sides such as, for example, tapes, mats, fabrics, plies, and the like, the carbon nanotube-forming catalyst can be disposed on one or both sides of the fiber material. Correspondingly, under such conditions, carbon nanotubes can be grown on one or both sides of the fiber material as well.

In some embodiments, carbon nanotube-infused fiber materials containing substantially parallel-aligned carbon nanotubes can be produced. Carbon nanotube-infused fibers containing substantially parallel-aligned carbon nanotubes are described in commonly owned U.S. patent application Ser. No. 13/019,248, filed Feb. 1, 2011, which is incorporated herein by reference in its entirety. In some embodiments, a carbon nanotube-infused fiber material that contains a fiber material and carbon nanotubes infused to the fiber material that are aligned substantially perpendicular to the surface of the fiber material can be reoriented so as to form a layer of infused carbon nanotubes that are aligned substantially parallel to the longitudinal axis of the fiber material.

In some embodiments, the substantially parallel-aligned carbon nanotubes can be crosslinked to one another. Crosslinking can be through covalent bonding and/or pi-stacking interactions. In some embodiments, pi-stacking interactions can occur through a crosslinking polymer.

In forming carbon nanotubes, growth tends to follow the direction of the applied electric field or magnetic field. By properly adjusting the geometry of the plasma spray or like carbon feedstock source and the electric field or magnetic field in a carbon nanotube growth process that produces substantially parallel-aligned carbon nanotubes, a separate realignment step after carbon nanotube synthesis can be avoided.

As described above, the carbon nanotube synthesis is performed at a rate sufficient to provide a continuous process for infusing spoolable length fiber materials with carbon nanotubes. Numerous apparatus configurations facilitate such a continuous synthesis as exemplified below.

In some embodiments, carbon nanotube-infused fiber materials can be prepared in an “all-plasma” process. In such embodiments, the fiber materials pass through numerous plasma-mediated steps to form the final carbon nanotube-infused fiber materials. The first of the plasma processes, can include a step of fiber surface modification. This is a plasma process for “roughing” the surface of the fiber material to facilitate catalyst deposition, as described above. As also described above, surface modification can be achieved using a plasma of any one or more of a variety of different gases, including, without limitation, argon, helium, oxygen, ammonia, hydrogen, and nitrogen.

After surface modification, the fiber material proceeds to catalyst application. In the present all-plasma process, this step is a plasma process for depositing the carbon nanotube-forming catalyst on the fiber material. The carbon nanotube-forming catalyst is typically a transition metal as described above. The transition metal catalyst can be added to a plasma feedstock gas as a precursor in non-limiting forms including, for example, a ferrofluid, a metal organic, a metal salt, mixtures thereof or any other composition suitable for promoting gas phase transport. The carbon nanotube-forming catalyst can be applied at room temperature in ambient environment with neither vacuum nor an inert atmosphere being required. In some embodiments, the fiber material can be cooled prior to catalyst application.

Continuing the all-plasma process, carbon nanotube synthesis occurs in a carbon nanotube-growth reactor. Carbon nanotube growth can be achieved through the use of plasma-enhanced chemical vapor deposition, wherein carbon plasma is sprayed onto the catalyst-laden fibers. Since carbon nanotube growth occurs at elevated temperatures (typically in a range of about 500° C. to about 1000° C. depending on the catalyst), the catalyst-laden fibers can be heated prior to being exposed to the carbon plasma. For the carbon nanotube infusion process, the fiber material can be optionally heated until softening occurs. After heating, the fiber material is ready to receive the carbon plasma. The carbon plasma can be generated, for example, by passing a carbon-containing feedstock gas such as, for example, acetylene, ethylene, ethanol, and the like, through an electric field that is capable of ionizing the gas. This cold carbon plasma is directed, via spray nozzles, to the fiber material. The fiber material can be in close proximity to the spray nozzles, such as within about 1 centimeter of the spray nozzles, to receive the plasma. In some embodiments, heaters can be disposed above the fiber material at the plasma sprayers to maintain the elevated temperature of the fiber material.

Another configuration for continuous carbon nanotube synthesis involves a special rectangular reactor for the synthesis and growth of carbon nanotubes directly on fiber materials. The reactor can be designed for use in a continuous in-line process for producing carbon nanotube-infused fiber materials. In some embodiments, carbon nanotubes are grown via a CVD process at atmospheric pressure and an elevated temperature in the range of about 550° C. and about 800° C. in a multi-zone reactor. The fact that the carbon nanotube synthesis occurs at atmospheric pressure is one factor that facilitates the incorporation of the reactor into a continuous processing line for carbon nanotube infusion to the fiber materials. Another advantage consistent with in-line continuous processing using such a zone reactor is that carbon nanotube growth occurs in seconds, as opposed to minutes (or longer), as in other procedures and apparatus configurations typical in the art.

Carbon nanotube synthesis reactors in accordance with the various embodiments include the following features:

Rectangular Configured Synthesis Reactors: The cross-section of a typical carbon nanotube synthesis reactor known in the art is circular. There are a number of reasons for this including, for example, historical reasons (e.g., cylindrical reactors are often used in laboratories) and convenience (e.g., flow dynamics are easy to model in cylindrical reactors, heater systems readily accept circular tubes (e.g., quartz, etc.), and ease of manufacturing. Departing from the cylindrical convention, the present disclosure provides a carbon nanotube synthesis reactor having a rectangular cross section. The reasons for the departure include at least the following:

1) Inefficient Use of Reactor Volume. Since many fiber materials that can be processed by the reactor are relatively planar (e.g., flat tapes, sheet-like forms, or spread tows or rovings), a circular cross-section is an inefficient use of the reactor volume. This inefficiency results in several drawbacks for cylindrical carbon nanotube synthesis reactors including, for example, a) maintaining a sufficient system purge; increased reactor volume requires increased gas flow rates to maintain the same level of gas purge, resulting in inefficiencies for high volume production of carbon nanotubes in an open environment; b) increased carbon-containing feedstock gas flow rates; the relative increase in inert gas flow for system purge, as per a) above, requires increased carbon-containing feedstock gas flow rates. Consider that the volume of an illustrative 12K glass fiber roving is approximately 2000 times less than the total volume of a synthesis reactor having a rectangular cross-section. In an equivalent cylindrical reactor (i.e., a cylindrical reactor that has a width that accommodates the same planarized glass fiber material as the rectangular cross-section reactor), the volume of the glass fiber material is approximately 17,500 times less than the volume of the reactor. Although gas deposition processes, such as CVD, are typically governed by pressure and temperature alone, volume can have a significant impact on the efficiency of deposition. With a rectangular reactor there is a still excess volume, and this excess volume facilitates unwanted reactions. However, a cylindrical reactor has about eight times that volume available for facilitating unwanted reactions. Due to this greater opportunity for competing reactions to occur, the desired reactions effectively occur more slowly in a cylindrical reactor. Such a slow down in carbon nanotube growth, is problematic for the development of continuous growth processes. Another benefit of a rectangular reactor configuration is that the reactor volume can be decreased further still by using a small height for the rectangular chamber to make the volume ratio better and the reactions even more efficient. In some embodiments disclosed herein, the total volume of a rectangular synthesis reactor is no more than about 3000 times greater than the total volume of a fiber material being passed through the synthesis reactor. In some further embodiments, the total volume of the rectangular synthesis reactor is no more than about 4000 times greater than the total volume of the fiber material being passed through the synthesis reactor. In some still further embodiments, the total volume of the rectangular synthesis reactor is less than about 10,000 times greater than the total volume of the fiber material being passed through the synthesis reactor. Additionally, it is notable that when using a cylindrical reactor, more carbon-containing feedstock gas is required to provide the same flow percent as compared to reactors having a rectangular cross section. It should be appreciated that in some other embodiments, the synthesis reactor has a cross-section that is described by polygonal forms that are not rectangular, but are relatively similar thereto and provide a similar reduction in reactor volume relative to a reactor having a circular cross section; and c) problematic temperature distribution; when a relatively small-diameter reactor is used, the temperature gradient from the center of the chamber to the walls thereof is minimal, but with increased reactor size, such as would be used for commercial-scale production, such temperature gradients increase. Temperature gradients result in product quality variations across the fiber material (i.e., product quality varies as a function of radial position). This problem is substantially avoided when using a reactor having a rectangular cross-section. In particular, when a planar substrate is used, reactor height can be maintained constant as the size of the substrate scales upward. Temperature gradients between the top and bottom of the reactor are essentially negligible and, as a consequence, thermal issues and the product-quality variations that result are avoided.

2) Gas introduction. Because tubular furnaces are normally employed in the art, typical carbon nanotube synthesis reactors introduce gas at one end and draw it through the reactor to the other end. In some embodiments disclosed herein, gas can be introduced at the center of the reactor or within a target growth zone, symmetrically, either through the sides or through the top and bottom plates of the reactor. This improves the overall carbon nanotube growth rate because the incoming feedstock gas is continuously replenishing at the hottest portion of the system, which is where carbon nanotube growth is most active.

Zoning. Chambers that provide a relatively cool purge zone extend from both ends of the rectangular synthesis reactor. Applicants have determined that if a hot gas were to mix with the external environment (i.e., outside of the rectangular reactor), there would be increased degradation of the fiber material. The cool purge zones provide a buffer between the internal system and external environments. Carbon nanotube synthesis reactor configurations known in the art typically require that the substrate is carefully (and slowly) cooled. The cool purge zone at the exit of the present rectangular carbon nanotube growth reactor achieves the cooling in a short period of time, as required for continuous in-line processing.

Non-contact, hot-walled, metallic reactor. In some embodiments, a metallic hot-walled reactor (e.g., stainless steel) is employed. Use of this type of reactor can appear counterintuitive because metal, and stainless steel in particular, is more susceptible to carbon deposition (i.e., soot and by-product formation). Thus, most carbon nanotube synthesis reactors are made from quartz because there is less carbon deposited, quartz is easier to clean, and quartz facilitates sample observation. However, Applicants have observed that the increased soot and carbon deposition on stainless steel results in more consistent, efficient, faster, and stable carbon nanotube growth. Without being bound by theory it has been indicated that, in conjunction with atmospheric operation, the CVD process occurring in the reactor is diffusion limited. That is, the carbon nanotube-forming catalyst is “overfed;” too much carbon is available in the reactor system due to its relatively higher partial pressure (than if the reactor was operating under partial vacuum). As a consequence, in an open system—especially a clean one—too much carbon can adhere to the particles of carbon nanotube-forming catalyst, compromising their ability to synthesize carbon nanotubes. In some embodiments, the rectangular reactor is intentionally run when the reactor is “dirty,” that is with soot deposited on the metallic reactor walls. Once carbon deposits to a monolayer on the walls of the reactor, carbon will readily deposit over itself. Since some of the available carbon is “withdrawn” due to this mechanism, the remaining carbon feedstock, in the form of radicals, reacts with the carbon nanotube-forming catalyst at a rate that does not poison the catalyst. Existing systems run “cleanly” which, if they were open for continuous processing, would produce a much lower yield of carbon nanotubes at reduced growth rates.

Although it is generally beneficial to perform carbon nanotube synthesis “dirty” as described above, certain portions of the apparatus (e.g., gas manifolds and inlets) can nonetheless negatively impact the carbon nanotube growth process when soot creates blockages. In order to combat this problem, such areas of the carbon nanotube growth reaction chamber can be protected with soot inhibiting coatings such as, for example, silica, alumina, or MgO. In practice, these portions of the apparatus can be dip-coated in these soot inhibiting coatings. Metals such as INVAR® can be used with these coatings as INVAR has a similar CTE (coefficient of thermal expansion) ensuring proper adhesion of the coating at higher temperatures, preventing the soot from significantly building up in critical zones.

Combined Catalyst Reduction and Carbon Nanotube Synthesis. In the carbon nanotube synthesis reactor disclosed herein, both catalyst reduction and carbon nanotube growth occur within the reactor. This is significant because the reduction step cannot be accomplished timely enough for use in a continuous process if performed as a discrete operation. In a typical process known in the art, a reduction step typically takes 1-12 hours to perform. Both operations occur in a reactor in accordance with the present disclosure due, at least in part, to the fact that carbon-containing feedstock gas is introduced at the center of the reactor, not the end as would be typical in the art using cylindrical reactors. The reduction process occurs as the fiber material enters the heated zone. By this point, the gas has had time to react with the walls and cool off prior to reducing the catalyst (via hydrogen radical interactions). It is this transition region where the reduction occurs. At the hottest isothermal zone in the system, carbon nanotube growth occurs, with the greatest growth rate occurring proximal to the gas inlets near the center of the reactor.

In some embodiments, when loosely affiliated fiber materials including, for example, tows or rovings are employed (e.g,. a glass roving), the continuous process can include steps that spread out the strands and/or filaments of the tow or roving. Thus, as a tow or roving is unspooled it can be spread using a vacuum-based fiber spreading system, for example. When employing sized glass fiber rovings, for example, which can be relatively stiff, additional heating can be employed in order to “soften” the roving to facilitate fiber spreading. The spread fibers which contain individual filaments can be spread apart sufficiently to expose an entire surface area of the filaments, thus allowing the roving to more efficiently react in subsequent process steps. For example, a spread tow or roving can pass through a surface treatment step that is composed of a plasma system as described above. The roughened, spread fibers then can pass through a carbon nanotube-forming catalyst dip bath. The result is fibers of the glass roving that have catalyst particles distributed radially on their surface. The catalyzed-laden fibers of the roving then enter an appropriate carbon nanotube growth chamber, such as the rectangular chamber described above, where a flow through atmospheric pressure CVD or plasma enhanced-CVD process is used to synthesize carbon nanotubes at rates as high as several microns per second. The fibers of the roving, now having radially aligned carbon nanotubes, exit the carbon nanotube growth reactor.

It is understood that modifications which do not substantially affect the activity of the various embodiments of this invention are also included within the definition of the invention provided herein.

Although the invention has been described with reference to the disclosed embodiments, those of ordinary skill in the art will readily appreciate that these embodiments are only illustrative of the invention. It should be understood that various modifications can be made without departing from the spirit of the invention. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and operations. All numbers and ranges disclosed above can vary by some amount. Whenever a numerical range with a lower limit and an upper limit is disclosed, any number and any subrange falling within the broader range is specifically disclosed. Also, the terms in the claims have their plain, ordinary meaning unless otherwise explicitly and clearly defined by the patentee. If there is any conflict in the usages of a word or term in this specification and one or more patent or other documents that may be incorporated herein by reference, the definitions that are consistent with this specification should be adopted.

What is claimed is the following:

1. A tooling comprising:
a composite comprising a matrix material and a carbon nanotube material,
wherein the composite has a coefficient of thermal expansion of less than about 5 ppm/° C.

2. The tooling of claim 1, wherein the composite has an enhanced thermal conductivity relative to a composite lacking the carbon nanotube material.

3. The tooling of claim 1, wherein the tooling comprises a template structure that is operable for forming a part thereon.

4. The tooling of claim 1, wherein the matrix material comprises a material selected from the group consisting of a polymer matrix, a metal matrix, a carbon matrix, a ceramic matrix, and combinations thereof.

5. The tooling of claim 1, wherein the carbon nanotube material comprises a carbon nanotube-infused fiber material.

6. The tooling of claim 1, wherein the carbon nanotube material is distributed non-uniformly in the matrix material.

7. The tooling of claim 6, wherein a concentration of the carbon nanotube material is highest at a surface of the composite.

8. A method for forming a tooling, the method comprising:
impregnating a matrix material with a carbon nanotube material to form a composite; and
shaping the composite into a template structure.

9. The method of claim 8, wherein impregnating comprises a technique selected from the group consisting of wet mixing, dry mixing, layering, in situ growth, chemical vapor infiltration, reactive melt infiltration, electrophoretic deposition, polymer impregnation and pyrolysis, sintering, colloidal deposition, sol-gel deposition, powder processing, and combinations thereof.

10. The method of claim 8, wherein shaping comprises a technique selected from the group consisting of die casting, mold casting, extruding, layering, machining, laser cutting, machine stamping, welding, prepreg formation, resin film infusion, chopped fiber layup, resin transfer molding and wet winding, vacuum assisted resin transfer molding (VARTM), pultrusion, extrusion, hand layup open molding, compression molding, thermoforming, autoclave molding, filament winding, injection molding, press molding, and combinations thereof.

11. The method of claim 8, wherein the matrix material comprises a material selected from the group consisting of a polymer matrix, a metal matrix, a carbon matrix, a ceramic matrix, and combinations thereof.

12. The method of claim 8, wherein the carbon nanotube material comprises a carbon nanotube-infused fiber material.

13. The method of claim 8, wherein the carbon nanotube material is distributed non-uniformly in the matrix material.

14. The method of claim 13, wherein a concentration of the carbon nanotube material is highest at a surface of the composite.

15. A method for forming a part, the method comprising:
disposing a part material on a tooling comprising a matrix material and a carbon nanotube material;
wherein the tooling provides a template structure for a part being formed thereon; and
curing the part.

16. The method of claim 15, further comprising:
disposing an intermediate material between the tooling and the part.

17. The method of claim 16, wherein the intermediate material allows for separation of the tooling from the part.

18. The method of claim 16, further comprising:
separating the tooling from the part.

19. The method of claim 15, wherein the part material comprises a material selected from the group consisting of a polymer, a metal, a ceramic, and combinations thereof.

20. The method of claim 15, wherein the tooling has a coefficient of thermal expansion of less than about 5 ppm/° C.

21. The method of claim 15, wherein the matrix material comprises a material selected from the group consisting of a polymer matrix, a metal matrix, a carbon matrix, a ceramic matrix, and combinations thereof.

22. The method of claim 15, wherein the carbon nanotube material comprises a carbon nanotube-infused fiber material.

23. The method of claim 15, wherein the carbon nanotube material is distributed non-uniformly in the matrix material.

24. The method of claim 23, wherein a concentration of the carbon nanotube material in the tooling is highest where the tooling is nearest the part.

25. The method of claim 15, wherein the part comprises one or more layers.

26. The method of claim 25, further comprising:
performing a consolidation process to the one or more layers comprising the part between layering of at least some of the one or more layers.

27. The method of claim 26, wherein performing a consolidation process comprises applying external heat to the part.

28. The method of claim 26, wherein performing a consolidation process comprises activating the carbon nanotube material to produce a thermal emission upon exposure to at least one condition selected from the group consisting near-infrared radiation, radio-frequency radiation, microwave radiation, electrical current, and combinations thereof.

29. The method of claim 15, wherein curing the part comprises applying external heat thereto.

30. The method of claim 15, wherein curing the part comprises activating the carbon nanotube material to produce a thermal emission upon exposure to at least one condition selected from the group consisting near-infrared radiation, radio-frequency radiation, microwave radiation, electrical current, and combinations thereof.
